(19) United States
(12) Patent Application Publication
(10) Pub. No.: US 2012/0130814 A1
(43) Pub. Date: May 24, 2012

(54) System and method for search engine result ranking

(76) Inventor: Paul Vincent Hayes, Union City, NJ (US)

(21) Appl. No.: 13/068,775

(22) Filed: May 20, 2011

Related U.S. Application Data
(63) Continuation-in-part of application No. 11/939,819, filed on Nov. 14, 2007.

(51) Int. Cl. G06Q 30/02; G06F 17/30

(52) U.S. Cl. 705/14.54; 707/709; 707/E17.014; 707/E17.108; 707/E17.044

(57) ABSTRACT

Search engine reliance on link-based ranking algorithms has been shown to delay the visibility of fresh content added to the World Wide Web (Web), relative to established content. Fresh content abstracts are randomly inserted into top ranked search results to achieve more even visibility coverage of the Web and improve overall search quality. Searcher behavior is monitored to infer a rank for the fresh content, and for established content. Rank that is so inferred is termed “ResultRank.” ResultRank is used to compliment link-based ranking schemes to improve web visibility and avoid a bias toward established links. Searcher satisfaction is monitored during this process since the quality of fresh content is unknown. A search engine extended enterprise metric (R metric) is introduced and designed to monitor aggregate searcher satisfaction. ResultRank and the R metric are used to complement existing ranking and pricing algorithms for sponsored results as well.

### RELATED APPLICATIONS

This application claims the benefit of U.S. Provisional Application Ser. No. 61/395;813, filed on May 18, 2010, titled “System and Method for Optimizing Search Engine Operations”, the entire disclosure of which is expressly incorporated herein by reference. This application claims the benefit of and is also a continuation-in-part of U.S. patent application Ser. No. 11/939,819, filed Nov. 14, 2007, the entire disclosure of which is expressly incorporated herein by reference. This application also claims the benefit of U.S. Provisional Application Ser. No. 60/859,034, filed Nov. 14, 2006, and U.S. Provisional Application Ser. No. 60/921,794, filed Apr. 4, 2007, the entire disclosures of which are both expressly incorporated by reference.

### BACKGROUND OF THE INVENTION

1. Field of the Invention

The present invention relates to ranking of search results returned by a search engine in response to a searcher-entered query. More particularly, the present invention relates to a system and method that uses a result-ranking algorithm that is not solely link-based in nature; but in addition incorporates inferred searcher satisfaction with the relevance of search abstracts into overall result-ranking.

2. Related Art

The Internet, the web, and search engine technology play an important role in the everyday lives of an increasing number of people.¹ The Web is the world's largest shopping center, library, travel agency, source of entertainment, means of communication, and source of news. Today, in English speaking countries, we have at best a duopoly in the Search Engine business, with Google and Microsoft's Bing the last two independent search engine brands standing. Google has approximately eighty-six percent of the search engine market globally.² We are approaching a monopoly in the search engine market. ¹ Global Policy Forum, Internet Users, 1995-2008, Internet World Stats http://www.globalpolicy.org/component/content/article/109/27519.html, as viewed Aug. 1, 2010.² Courtesy of NetMarketShare, April 2010, As viewed Sunday, May 16, 2010) http://marketshare.hitslink.com/search-engine-market-share.aspx?qprid=4

The underlying structure of the Web is the primary mechanism by which information is located, organized, ranked, and presented to those who use Search Engines. The structure of the Web can be thought of as a series of nodes (i.e. pages or web sites) and directed links (HTML) between the nodes. Search Engines rely primarily on link-based ranking algorithms. Search engines routinely “crawl” Web links and index existing content in preparation for future search queries. A typical search query will match, in terms of relevancy, multiple sites, often millions of sites, in nearly equivalent ways. A common means of further differentiating these matching sites is to rank them based on the structure of the Web. Google uses the structure of the web, for example, to calculate PageRank, an early and popular link-based ranking algorithm.³ PageRank assumes that the more incoming links a particular web site has; and in turn the more incoming links each of those connecting sites have, and so on; the higher the rank that particular web site has. ³ Brin, Sergey; Page, Lawrence; The Anatomy of a Large-Scale Hypertextual Web Search Engine, 1998, http://infolab.stanford.edu/˜backrub/google.html

The directed links are made by web-masters from their site to other sites. In an ideal world a web master would make a link to another site only when they have judged that site to be of good quality. Regardless, the choices made by web site owners determine the structure of the Web. The structure of the Web is used to rank nodes. Given the typical large number of nodes that match a query, the ranking process essentially determines which sites are visible to search engine users and which sites are invisible. This is the case since a typical search engine user never looks past the first page (typically the top 10 results) of the Search Engine Result Presentation (SERP). Given the rapid growth the Web it has become increasingly difficult for search engines to maintain an accurate, complete, and up-to-date index of sites. Google has declared victory in the search engine index size wars. Google is “proud to have the most comprehensive index of any search engine” and in 2008 estimated that there were over 1 trillion “unique URLs on the web at once.” As per Google: “So how many unique pages does the web really contain? We don't know; we don't have time to look at them all!:-)”⁴ “Even Google, the leading search engine, indexes less than 1% of the entire Web. . . . Even with a distributed crawling system it is still impossible to consider downloading a large portion of the Web.”⁵ Although Google's algorithms are proprietary, based on a publication contributed to by Larry Page (Google Co-founder), it is likely that Google has employed a strategy of using PageRank to direct its crawling of the Web.⁶ If so, then fresh content is less likely to be visited by a crawler and thus less likely to be indexed, or up-to-date in the index. A web page can be ranked (link-based) only if it has first been crawled and indexed. Thus a searcher without special prior knowledge of a web page's URL will be unable to locate it. It will be essentially invisible. ⁴ The Official Google Blog, Insights from Googlers into our products, technology, and the Google culture, “We knew the web was big . . . ”, Jul. 25, 2008 10:12:00 AM, http://googleblog.blogspot.com/2008/07/we-knew-web-was-big.html, as viewed 1 Aug. 2010.⁵ Y. Wang and D. DeWitt. Computing pagerank in a distributed internet search system. In Proceedings of the International Conference on Very Large Databases (VLDB), August 2004.⁶ Cho, J., Garcia-Molina, H., Page, L., “Efficient Crawling Through URL Ordering,” Department of Computer Science, Stanford University, In: Seventh International World Wide Web Converence (WWW 1998), Apr. 14-18, 1998, Brisband, Australia.

Unfortunately, research has shown that search engine reliance on link-based ranking has a reinforcing effect on the existing structure of the Web.⁷ In other words, the more incoming links a web site has the more visible it is, and the higher probability it has of getting new links. In terms of links then, the rich get richer rule applies. Barabasi has shown that the distribution of links on the Web follows a power law.⁸ ⁷ Cho & Roy, UCLA, WWW2004, May 17-22, 2004, NY ACM xxx.xxx, http://oak.cs.ucla.edu/˜cho/papers/cho-bias.pdf, Introduction, Experimental Study.⁸ Albert-Laszló Barabási and Réka Albert, “Emergence of Scaling in Random Networks,” Science 286, no. 5439 (1999).

This supports the conclusion that the accumulation of links is accelerating for sites with many links to begin with.⁹ ⁹ Alejandro M. Diaz, “Through the Google Goggles: Sociopolitical Bias in Search Engine Design, Submitted to the Program in Science, Technology and Society, Stanford University, May 2005, Pgs. 73-74.

The end result is that it's increasingly difficult for new web content to gain visibility, regardless of actual relevance and quality.¹⁰ Instead we have a system that rewards older more established web sites with increased visibility, while penalizing the visibility of fresh sites—without regard to relevance or quality. This effect is inherently, unfair to both the search engine user and to web-masters seeking visibility for quality fresh sites. ¹⁰ Cho & Roy, UCLA, WWW2004, May 17-22, 2004, NY ACM xxx.xxx, http://oak.cs.ucla.edu/˜cho/papers/cho-bias.pdf, Introduction, Theoretical Study.

Google took in $23.7 billion in revenue in 2009. Ninety-seven percent of this revenue came from advertising.¹¹ This statistic underscores the fact that visibility and the associated traffic are valuable. Thus visibility can be a large part of the incentive to construct a web site. To the extent link-based ranking reduces visibility for new sites; it also reduces the incentive to add new sites to the web. ¹¹ Helen Walters, Bloomberg Businessweek, Monday Apr. 26, 2010, “How Google Got its New Look”, as viewed May 5, 2010, 12:01 PM EST, http://www.businessweek.com/print/magazine/content/10_{—}20/b4178000295757.htm

A typical search engine user is not a web site owner. There are many more search engine users then there are web masters, yet the web masters decide which sites are visible to search engine users. Thus we have a representative form of decision making rather than a democratic one, when it comes to structuring the Web. Further, Web Master considerations, when deciding to link to other sites, may have little to do with the relevance of future search queries. As such, we have a lack of congruence between the motives for making links and the goal of finding the most relevant sites for search queries.

Further the indirect nature, in which query relevance decisions are made, makes it more possible to game the system in order to gain unwarranted visibility. A new industry called Search Engine Optimization (SEO) has sprung up to address the visibility problem.

The goal of both the so-called white hat and black hat SEO practitioner is to gain link-based rank for particular client sites; and thus gain visibility. Search engines like Google spend significant resources to counter attempts to game or artificially manipulate their PageRank algorithm.

A search engine can automatically monitor searcher interaction with SERP content. This monitoring is called “click-analysis” or “click-stream analysis.” This sort of monitoring is often done using toolbars, or web browsers; and is a commonly used means of inferring the level of searcher satisfaction with individual search results and with the SERP in general.¹² ¹² Singel, Ryan, “Google Catches Bing Copying; Microsoft Says ‘So What?’”, Wired, Feb. 1, 2011, 2:31 pm, http://www.wired.com/epicenter/2011/02/bing-copies-google/, as accessed Mar. 15, 2011. http://www.stanford.edu/group/reputation/ClickThroughAlg_Tutorial.pdf

In 2005, Null suggested a means of ranking that bypasses “ . . . the somewhat indirect logic of link analysis and the reputation system it is based on . . . ”¹³ ¹³ B. Null, Stanford, May 2005, “A Discussion of Click-Through Algorithms for Web Page Ranking”, http://www.stanford.edu/group/reputation/ClickThroughAlg_Tutorial.pdf

In an effort to better study search session behavior, Null proposed modeling each yes/no click-through decision xᵢ,as an independent Bernoulli trial. A key and reasonable assumption is that a typical searcher reviews a SERP from top to bottom. Each user that examines a page abstract (e.g. a search result) has a probability of clicking-through to that page of pᵢ.¹⁴ ¹⁴ B. Null, Stanford, May 2005, “A Discussion of Click-Through Algorithms for Web Page Ranking” http://www.stanford.edu/group/reputation/ClickThroughAlg_Tutorial.pdf

Null's calculation and reasoning identify a key problem in using the probability vector, pᵢ to do the ranking: “ . . . how can a search engine get this information [probability vector] over time without sacrificing too much in the way of performance?”¹⁵ ¹⁵ B. Null, Stanford, May 2005, “A Discussion of Click-Through Algorithms for Web Page Ranking”

It has been said of Google, for example, that, “one of the benefits of having 268 million users a day is that you can roll out new products to a fraction of them and still have the benefits of a large sample size.”¹⁶ So, for example, if Google injected 3,000,000 fresh 100 results (e.g. links to fresh web pages) into SERPs each day this would impact less than 1.12% of the SERPs provided daily. ¹⁶ Helen Walters, Bloomberg Business week, Monday Apr. 26, 2010, “How Google Got its New Look”, as viewed May 5, 2010, 12:01 PM EST, http://www.businessweek.com/print/magazine/content/10_{—}20/b4178000295757.htm

Accordingly, what would be desirable, but has not yet been provided, is a system and method that provides the following:
Equitable visibility to all sites, both fresh and established;
Visibility which is based on quality and relevance and decided in a democratic manner;
Harvesting of the currently wasted work, which is voluntarily done by search engine users;
Improvement on the link-based ranking algorithm used to order individual result abstracts in Search Engine Result Presentations (SERPs);
Does not destroy searcher confidence in the quality of a search engine's SERP while harvesting their work.
A method that will make use of existing ranking systems immediately and evolve them into ranking systems that incorporate ranking based on searcher opinion.
A method that will simultaneously be applicable to either an established, popular search engines or a new search engine with little or no market share

### SUMMARY OF THE INVENTION

The present invention relates to an automated method designed to counter the above-described rich get richer effect, where web sites with a lot of links tend to gain new links faster than web sites with no or few links. Countering the rich get richer effect is expected to improve visibility for fresh content.

Three novel aspects of this invention include the following:

The first main aspect of the invention is to constantly harvest work done by the searcher, through the use of click-analysis, in order to re-rank results in preparation for future SERP generation.

The second step is to randomly introduce “fresh” content into top ranked results. Here the term fresh refers to web sites that have no overall rank.

The third feature of this invention is to monitor an extended enterprise metric. The metric is designed to vary directly with search engine user satisfaction with SERPs.

It is recognized that the introduction of fresh content into top ranked results may be less likely to satisfy a searcher. One intended use of the metric is as a feedback mechanism on searcher satisfaction levels. As such, it is the purpose of the metric to regulate the rate at which fresh content is introduced. The intended purpose is to retain some minimum level of searcher confidence in the quality of the presented results; while at the same time extracting work from the searcher.

### ResultRank

Searchers and web content providers can be thought of as members of a search engine's extended enterprise. As such these members are “virtually” integrated the Internet; rather than being vertically integrated in the more traditional sense.¹⁷ The approach of this invention uses searchers as value added members of the search engine's extended enterprise. The work done during a search session, when a searcher chooses between a handful of results, is harvested, by the search engine using this invention, and used to develop a relative ranking for fresh sites that have no link-based ranking. The searcher work is also used to re-rank established sites based on the searcher's opinion, as inferred by the search engine. In this manner a more direct search result based ranking is generated for both fresh and established content. This is referred to as “ResultRank” by this invention. ResultRank is then independent of link-based ranking and is used to complement link-based rank, in the generation of future SERPs. ¹⁷ Kamauff, J. W., Smith, D. B., Spekman, R., “Extended Enterprise Metrics: The Key to Achieving Synthesized Effectiveness, Journal of Business & Economics Research, 2004, Vol. 2, Number 5, Pg. 43

An overall ranking is used to generate SERPs. The overall ranking is formally defined as a sort of weighted-average of the ResultRank value and the Link-based Rank value, as follows:

Overall rank=[ResultRank*N1+Link-Based Rank*N2]/(N1+N2)

### Where

N1 is the number of times that the ResultRank has been adjusted by searcher inferred opinion.

N2 is the number of incoming links to the associated search abstract (without regard to the authority of those links).

We can see that the ResultRank calculated by this invention, has the following desirable characteristics:

1) If the ResultRank is zero, then N1 is zero and the overall rank is equal to the link-based rank.

2) If the Link-Based Rank is zero, then N2 is zero and the overall rank is equal to the ResultRank.

3) The more links coming into an associated web-site, the higher the contribution of Link-based rank to the overall rank.

4) The more time's searcher opinion has been inferred to adjust the ResultRank, the higher the contribution of ResultRank to the overall rank.

5) The overall rank is more democratically arrived at, since this invention follows the principal of one link per web-master, one adjustment per searcher, and indeed one-person one vote.

6) The ResultRank, and thus overall rank, is continuously adjusted, automatically, in real-time in a manner that directly relates to query relevance.

More specifically, click-analysis techniques are used by this invention to infer the opinion of the searcher as to the proper ranking of the results in the SERP. It is likely that the searcher may have a different opinion as to the ranking, since the searcher is intimately aware of the meaning of the query they just entered and what they want to learn as a result. Null's model of a search session is relied upon during the click-analysis. It is assumed that the SERP is examined in a top-down manner by the searcher. If a searcher first clicks-through on the top ranked search abstract, it is inferred by this invention that the searcher agrees with the search engine's ranking of at least the top two abstracts.

If the searcher, for example, first clicks-through on a lower ranked result, it is inferred by this invention that the searcher believes the result first clicked-through on should have been the top ranked result. The search engine monitors the click-through events of the searcher. Immediately following each click-through event, a search engine using this invention, makes a calculation to adjust the ResultRank attributes of each related search result abstract. In other words, for example, if result abstracts are presented in the SERP in order A, B, C; and the searcher first clicks-through on result C; then the search engine infers that in the opinion of the searcher, the correct presentation order and rank should have been C, A, B. In this case, the search engine of this invention immediately re-calculates the ResultRank associated with each of the three related search abstracts in order to make the overall rank of each result abstract conform to the searcher's inferred opinion.

If this is the first time that an established search abstract (e.g. a search abstract that has a link-based rank) is evaluated in this manner it will have no ResultRank and its associated N1 value will be zero (0). In this case the initial ResultRank is taken to be equal in value to the link-based ranking associated with this search abstract. In addition, the initial N1 value is taken to be equal to the N2 value. In this manner we construct an initial ResultRank and N1 count such that its use would not have changed the overall rank of the abstract. We now have an initial ResultRank and initial N1 for our established abstract. If this is a fresh content abstract, then both its link-based rank and initial ResultRank will be zero. In this case both N1 and N2 are also zero. Thus a fresh content abstract initially has a ResultRank value of zero, a link-based rank of zero, and weights N1 and N2 equal to zero. In the event that fresh content has been inserted into the SERP, it is a special case. The algorithm used to adjust the inferred ResultRank of effected search abstracts is discussed further below, for this case.

We want to adjust overall rankings in a minimally invasive and yet realistic manner, so as to effect subsequent SERP generation only to the extent inferred from the searcher. It is desirable to keep the same range of overall rankings. The range is spanned by the initial overall rankings of search abstracts A (high-end of the range) and C (the low end of the range). In addition, we know that certain terms of the expression used to calculate the overall rankings have not yet changed, such as N1, N2, and the link-based ranking, so it is logical to keep them fixed in this process. Therefore, overall rank values are adjusted in a logical manner by solving an equation and allowing ResultRank to be the independent variable. The original overall rank value for abstract A, in this example, is set equal to the expression used to calculate the new overall rank value for result C (clicked-through on first by the searcher in our example). The original overall rank value for B is set equal to the expression used to calculate the new overall rank value for result A. Likewise, the original overall rank value for B is set equal to the expression used to calculate the new overall rank value for result C. ResultRank is allowed to change in all three of these equations in order to balance the equations. Thus in a subsequent generation of this SERP, the newly calculated ResultRank for each abstract would produce a new overall rank value for each of these three abstracts. This newly produced set of overall rank values would, all other things held constant, produce a SERP with result abstracts in the presentation order as inferred from the searcher, namely in order C, A, B.

For example, assuming the overall rank value for result A is given by O_{A} and assuming the expression used to calculate the overall rank value for abstract C is given by:

[ResultRank*1+Link-Based Rank*N2]/(N1+N2)

We formulate and solve the first equation mentioned above, allowing the ResultRank of abstract C to vary in order to balance the equation. We start by making the following assignment:

O_{A}=[ResultRank*N1+Link-Based Rank*N2]/(N1+N2)

And then we balance the equation by allowing ResultRank only, to vary from its initial condition:

→[ResultRank*N1+Link-Based Rank*N2]=(N1+N2)*O_{A}

→ResultRank*N1=[(N1+N2)*O_{A}]−[Link-Based Rank*N2]

→ResultRank=[(N1+N2)*O_{A}−(Link-Based Rank*N2)]/N1

In this manner we calculate a new ResultRank for abstract C which will make the overall rank of abstract C equal to the original overall rank of abstract A. ResultRank is so adjusted for all impacted search abstracts, in this case C, A, and B. This puts into effect and accounts for the inferred opinion of the searcher. The adjustment is done immediately in order to keep pace with a searcher's click-through events. In addition, in this example, the N1 counts associated with search abstracts C, A and B are incremented by one count, immediately following the adjustments made to ResultRank. The adjustment of the N1 counts of the re-ordered abstracts is a means of tracking the number of times that a search engine has inferred a searcher's assessment of rank. We track this statistic and use it to weight the associated ResultRank, thus giving more weight to ResultRank in the overall rank, the more times an independent searcher's opinion has been inferred and taken into account.

### Handling of Fresh Content

This invention is a solution to Null's dilemma. This invention ranks results using a combination link-based and result-based algorithm. In order to begin with reasonable performance, a search engine initially over-weights the link-based portion of the ranking algorithm. The search engine, using this invention, then gradually introduces fresh content, mixed with the top ranked results. As searchers review the SERP and make their click-past/through choices they are doing work. Searchers review both ranked and fresh content side-by-side. Search engine users are applying their understanding and experience in evaluating the relevance of the fresh content to the specific queries they have entered. It's then incumbent upon the search engine to harvest the results of searcher evaluation of the search result abstracts. A search engine can automatically monitor searcher interaction with fresh content as it's presented alongside content with high link-based ranking. Thus direct user evaluation is used to extrapolate the result-based ranking (ResultRank) component of the algorithm (e.g. Null's probability vector) from the link-based ranking, for fresh content.

In a preferred instance of this invention the fresh content is always inserted between the top and second ranked result of the SERF. Thus if the searcher clicks-through on the abstracts in the order that they are presented, we will assume that the searcher is relying completely on the search engine ranking and we will not adjust the ResultRank of the inserted fresh content. It is only if the searcher clicks-through on a link out of sequence of the presentation order that we score this as an adjustment of ResultRank for the inserted fresh content. In this latter case, it is considered safe to infer that the searcher has expressed their (own different) opinion as to how the SERP should have been ordered.

For example, if fresh content is inserted in presentation spot B we have initial presentation order of A, B. If the user/searcher's first click-through is on search result abstract B, then we infer that in the searcher's opinion, the presentation rank should have been B, A instead of A, B. We recall from the discussion above, that fresh content has no initial ranking of any type, so we need to account for this when applying our algorithm to adjust the ResultRank for abstracts A and B. As usual, we formulate two equations and then balance the equations to calculate a new ResultRank for both abstracts. As usual, the one equation is formulated by setting the initial overall ranking for result A equal to the expression for search result B. In this case, we take the expression for result B to be just ResultRank, since B is fresh content with zero initial values for ResultRank, link-based rank, N1 and N2. The end result is to assign the overall rank for result A to the ResultRank for result B. This makes sense since result B has no link-based rank. We have adjusted ResultRank for the fresh content in a reasonable manner. The second equation would normally be formulated by assigning the expression used to calculate the overall ranking for initial result A to be equal to the overall ranking for result B.

However, in this case result B is fresh content and has no initial overall ranking. So in this special case we formulate the equation by using an overall ranking for result B that is generated using the average of the overall ranking for result A and the overall ranking of result C. This produces a reasonable overall ranking for fresh content B and thus drives a reasonable adjustment to the ResultRank for effected result abstract A. We then increment the N1 counts for result abstracts A and B by one. From this point on B is no longer fresh content and has a non-zero overall ranking, as derived from the overall rank of adjacent result A.

A search engine cannot crawl fresh content, which has no overall rank and thus no link-based rank, and thus no incoming links to be crawled. The search engine has the problem of locating the fresh content. This invention solves this problem by allowing the web-masters of fresh content web sites to submit their URL for evaluation by the search engine. This submittal process is relied on by one embodiment of this invention to establish and maintain a set of fresh content.

### Reliance Metric, R

Also provided by this invention is an objective, automated, real-time, and inexpensive means of constantly monitoring searcher satisfaction with the search engine's performance. The extended enterprise metric, a part of this invention, is used to accomplish this function. By monitoring aggregate searcher satisfaction a search engine can gauge how rapidly fresh content can be inject into the top ranked results. The goal is to populate Null's probability vector, “ . . . without sacrificing too much in the way of performance.”

Given the typical large number of searchers that a popular search engine has per day, there is reason to believe that sufficient brand margin exists to allow fresh content to be randomly inserted and evaluated (ranked) without material loss of confidence in a typical popular large search engine.

Under such a system, as high quality fresh content gains visibility it is likely to gain links in proportion to the quality of its content, and thus eventually gain in link based ranking as well. As older more established content is presented alongside fresh content, it is likely to lose overall rank if its relative quality is less then deserved. Established content that is no longer seen by the average searcher as relevant will lose ResultRank to fresh content. The loss of ResultRank will result in a loss of overall rank, which will result in a loss of visibility. The loss of visibility will then likely result in a loss of incoming links; and associated link-based rank. Thus with the use of this invention, over time, it can be expected that a particular web site's link-based ranking will tend to follow the ResultRank. As ResultRank increases, eventually link-based rank will increase. As ResultRank decreases, eventually link-based rank will decrease.

The metric discussed above is defined as part of this invention and is called Searcher Reliance (R). In a sense R is a measure of the extent to which a searcher relies on the search engine's ranking of result abstracts in a SERP. If searchers completely rely on the search engine's ranking, they will immediately “click-through” on the top ranked/presented result. If searchers do not completely trust the search engine they might, for example, study the SERF for a time, “click-past” the top result, and “click-through” on the second ranked result. Clicking-through on anything other than the top ranked result first, is taken as an indication by this invention, that searchers rely less on the search engine ranking, and more on their own judgment as to relevancy to the query. This is logical since; in general, each searcher values their time and wants to get to a relevant web page as quickly as possible. Therefore, searchers are only motivated to spend their time reviewing the SERP, if they do not completely rely on the search engine to correctly rank the results. Thus if a searcher clicks on the second ranked result, for example, it can be inferred that the user has done some work in applying their own judgment and experience, as to query relevance. They did work since they did not blindly trust the search engine. In such a case, the searcher is assumed to have read the first and second ranked abstracts and made their decision. The metric of this invention is estimated from a series of experiments in which the normal presentation order of the top two results is switched. Swapping the presentation order allows the effects of random user clicking to be separated from the effects of deliberate application of a user's judgement. The extent to which the users pick the top ranked result, regardless of its presentation order, becomes a measure of the extent to which searchers are doing work. In the converse, the extent to which users pick the top presented result, regardless of presentation order, is used as a measure of the extent to which users blindly trust the search engine This invention takes presentation order clicks as an indirect measure of an average searcher's a priori satisfaction with the search engine's ability to generate a correctly ranked SERP.

Thus, as part of this invention, the metric, R can be thought of as the a priori measure of the average searcher's perceived quality of a search engine, or their satisfaction with the search engine; in terms of its ability to correctly rank results based on query relevance. As part of this invention then, the higher R a search engine is able to engender; the higher the rate at which the search engine can afford to inject fresh content into its SERPs. More formally, R is defined as shown below, in terms of Null's Bernoulli trial model of a search session:

R=(P[A]/P[A|b])−1

which is read as “the probability of event A divided by the probability of event A given prior event b, less one;”

and is equivalent to the following:

R=(P[B]/P[B|a])−1

which reads as “the probability of event B divided by the probability of event B given prior event a, less one.”

Where,

“A” represents the event that the top ranked result, is presented as such, and is clicked-through on by the searcher.

“B” represents the event that the second ranked result, is presented first, and is clicked-through on.

“B|a” represents the event that the top ranked result, is presented first, but is clicked-past.

“A|b” represents the event that the second ranked result, is presented first, but is clicked-past.

Thus we see that R can be calculated based on data used to estimate the above probabilities. Performing a series of two part experiments is used to generate the required data.

In the first part of the experiment the overall order is the same as the presentation order and is calculated and presented by the search engine of this invention to be A, B. As such, data is collected to estimate the probability of event A occurring, or P[A]; as well as the probability of B given prior event a, or P[B|a].

In the second part of the experiment the overall order is calculated to be A, B; but the presentation order is controlled by the search engine B, A; and data is collected to estimate P[B], as well as P[A|b]; or the probability of event A, given prior event b. Thus data is collected from both parts of the experiment and combined to estimate the various probabilities, and in turn estimate R.

As a part of this invention, R is expected to have the following desirable characteristics:

1) From the definition, R can increase to a very large number (bound by infinity), if P[A] and P[B] were to go to 1, while P[A↑b] and P[B|a] were to go to 0; respectively. However, it is unlikely that P[A] will approach 1, as P[A|b] approaches 0. In fact it is more likely that P[A|b] will vary directly with P[A], as P[A] approaches 1. Likewise for P[B|a] and P[B].

2) R goes to 0 when P[A] approaches P[A|b]; likewise when P[B] approaches P[B|a].

3) If P[A|b]>P[A], then R<0. Likewise if P[B|a]>P[B], then R<0.

4) From the definition, we can see that if P[A]=0, and P[A|b]=1, then R is at a minimum of −1. Likewise if P[B]=0, and P[B|a]=1, R is at a minimum of −1. However, this is unlikely as we expect that P[A|b] will vary directly with P[A], such that as P[A] goes to 0, so will P[A|b]. Likewise for P[B] and P[B|a].

Of course, in either part of this experiment, the searcher will be free to select results C, D, E, . . . (e.g. the 3^{rd} ranked result, fourth ranked, fifth, etc). In this event, this invention makes the simplifying approximation that any such searcher selection (click-through on a result abstract other than A or B) will be treated as a click-through on result B in the first part of an experiment. Thus any such click-through will be used to increase the value of our estimate for P[B|a], if the search engine is conducting the first part of the experiment. Any such click-through will increase the estimate of P[B] (if the search engine is conducting the second part of the experiment). This will insure that the two probabilities defined based on part one of the experiment are equal to one (e.g. P[A]+P[B|a]=1); and that the two probabilities defined for part two of the experiment are also equal to one (e.g. P[B]+P[A|b]=1). This simplifies sample taking and estimation of the probabilities.

Probabilities are estimated by setting them equal to the percentage of the time corresponding events are observed. For example, let's assume both parts of 10 experiments have been completed. Let's assume That the search engine has recorded 8 “A” events, and 2 “B|a” events from the first part of the experiments when results are presented in order A, B. On the other hand, for part 2 of the experiments (presentation order is B, A) let's assume that the search engine has recorded 6 “B” events and 4 “A|b” events. This would result in estimating (based on 10 samples) that:

1) P[A]=0.8,

2) P[B|a]=0.2

3) P[B]=0.6

4) P[A|b]=0.4

This would result in one estimate of R=(0.8/0.4)−1=2−1=1

and a second estimate of R=0.6/0.2−1=3−1=2

giving an average estimate of R=(1+2)/2=1.5

One might intuitively assume that the same query and resulting SERP should ideally be used in both parts of the experiment. However, based on generally accepted practice it is acceptable and even preferable, to combine data from different queries for the different parts of the experiment, in the estimation of R. In this manner, the results are made independent of the query and independent of the part of the experiment.

First we note that the user click events associated with a given pair of results, presented in order AB or BA are essentially independent of the events associated with a different pair′ of results presented in order A′B′ or B′A′. Thus the resulting estimates of probabilities, from each set of result pairs are independent as well. However, it is also reasonable to assume that R is the same for a given user, regardless of the search query or the SERP. This observation allows us to assume that the estimates of R, across multiple pairs of results are identical random variables. We thus have the desired independent and identically distributed random variable in R (e.g. the well-known “iid” criteria). The invention makes the simplifying assumption that the underlying probability distribution function is a Normal distribution. Given a Normal distribution, according to the Central Limit Theorem, smaller sets of data for different pairs of results can be used to effectively estimate R.¹⁸ Traditionally, 29 has been deemed a “large” N (number of samples), but more recent research favors using as many as 250 samples. More samples thus help to compensate for our assumption and preserve accuracy in the event that the population may be skewed away from a Normal distribution.¹⁹ In order to improve accuracy of the value R and keep it up-to-date, we continuously update our estimates of the probabilities and average the result obtained from the two definitions presented above: ¹⁸ Wikipedia article, http://en.wikipedia.org/wiki/Central_limit_theorem, accessed 6 Feb. 2008 at 6:20 pm, and last modified 04:54, 29 Jan. 2008.¹⁹ Yu, Chong Ho; Behrens, John T. “Identification of Misconceptions in the Central Limit Theorem and Related Concepts and Evaluation of Computer Media as a Remedial Tool”; Arizona State University, Spencer Anthony, University of Oklahoma, Paper presented at the Annual Meeting of the American Educational Research Association, Apr. 19, 1995, Revised in Feb. 12, 1997, http://www.creative-wisdom.com/pub/clt.rtf, accessed 24 Mar. 2008

Such that our estimate of R is given by

R_{average}=[(P[A]/P[A|b])−1+(P[B]/P[B|a])−1]/2

→R_{average}=(P[A]/2*P[A|b])+(P[B]/2*P[B|a])−1

### Other Variations of the Invention

In one embodiment of this invention, the Reliance metric R is used to selectively regulate either the rate at which ResultRank is updated, or the extent to which ResultRank is used to calculate overall rank. This can be done simply by using R to determine how many adjustments to ResultRank are required before N1 is increment by one (instead of incrementing N1 once per adjustment of ResultRank). Should ResultRank be deemed to be inaccurate or unstable to the point that the search engine may fear lose brand strength or share of the search market, then the effect of ResultRank can be removed and link-based ranking can be used as the overall rank. This can be done by either permanently or temporarily curtailing either the adjustment of ResultRank to reflect searcher opinion, or the use of ResultRank in the calculation of the overall rank. Simply using R to temporarily adjust the Ni weight downward for all search abstracts can do this. In one embodiment of this invention, this would act as a failsafe method to instantly return all SERP ordering to be completely dependent-on link-based ranking. In another embodiment of this invention R could be used to instantly halt (or slow down) the re-calculation of ResultRank. This might be desirable, under some circumstances of heavy loading, in order to speed-up the operations of the search engine. This capability may also be useful under some circumstances in order to conduct experiments yet to be defined.

In another instance of this invention it might be found useful to selectively disable the adjustment of ResultRank based on the inferred opinion of select individual searchers which are for whatever reason no longer trusted.

Unscrupulous searchers, their agents, or their software programs may attempt to repeatedly enter a query designed to return a SERP with a particular search result present They may then repeatedly click-through on this particular result, without regard to relevance, to artificially elevate its ResultRank. In these cases, an instance of this invention might find it useful to selectively disable the adjustment of ResultRank based on an individual searcher's click behavior.

In another instance of this invention, it may be useful to allow adjustment to ResultRank, based on an individual searcher's click-through on a specific result abstract, only once during a specified period of time. This measure might be made to stabilize ResultRank and to make click-fraud more difficult. Uniquely identifying information such as a source IP address might be used to track the source of a click-through on a particular result (normally a searcher) and preclude additional ResultRank adjustments either for the particular result and/or for all results based on clicks from this searcher for a selected period of time.

In another instance of this invention it may be useful to apply the same algorithm used to initially determine and continuously adjust ResultRank for organic results, described in detail above, to the presentation order of sponsored results. In this case, ResultRank could be used to compliment a monetary based-ranking. The monetary based rank being determined by the sponsor's bid for a particular key word. In other words, a sponsor's bid is used to determine a portion of the overall rank of a sponsored search result abstract much like link-based rank is used to contribute to the overall rank of an organic search result abstract. It is desirable for the search engine to display sponsored links that a searcher will find relevant and click-through on. This is the case since search engines have been known to charge the sponsor on a per click-through basis. Given that ResultRank is a direct measure of the likelihood of searchers to click-through on a particular sponsored result, it might be useful to encourage sponsors which provide popular links by reducing their fee based on their earning a high ResultRank. In other words as ResultRank increases, the sponsor might expect the search engine to charge them less on a per-click basis.

In another instance of this invention the metric R could be used to adjust the value paid by sponsors for sponsored results and/or keywords. In other words, the higher the R value, the more reliance a searcher has in the search engine to properly rank results (sponsored results in this case), and thus the more likely a searcher is to blindly click-through on results, following the presentation order. Therefore the more valuable is the placement of sponsored results, thus the sponsor payment is increased.

In another instance of this invention the search engine of this invention is called the native search engine and a second search engine is used to send the search queries to. The second search engine may use ranking algorithms which are unknown to this invention. The second search engine is called a foreign search engine. In this case, the web browser is in communication with both the native and foreign search engines. The web browser forwards the search query to the foreign search engine and intercepts the SERP which is returned, sharing the contents of the SERP with the native search engine. Further the web browser is used to monitor the click activity and interaction of the searcher with the SERP, communicating this information back to the native search engine. The native search engine is thus able to infer ResultRank by using its own existing ranking values for the specific search results effected in the SERP as a basis for adjusting ResultRank based on inferred searcher behavior. The native search engine is able to alter the contents of the SERP using the web browser prior to presentation to the searcher. This ability allows both fresh content to be inserted into the SERP and experiments to be performed in order to estimate the reliance metric R. In the event that the native search engine does not have a ranking value for specific search results returned in the SERP by the foreign search engine, the native search engine will treat the search results as if they were injected fresh content into the SERP and extrapolate as required from the results in the SERP for which the native search engine does have ranking information for. In the event that insufficient ranking information is available to the native search engine to extrapolate, a decision is made not to adjust ResultRank as a result. However, the search session activity can be saved by the native search engine and adjustments to ResultRank can be made at later time, should the search engine gain sufficient ranking information to extrapolate in the interim.

In one instance of this invention the web browser is not a part of this invention except that it remains in communication with the native search engine by means of having had a toolbar plugin installed into it. The toolbar plugin is then able to offer a voting mechanism for specific results in order to strengthen the inferences made as to opinion of the searcher. The toolbar is able to communicate the search query back to the native search engine and to intercept the SERP received from the foreign search engine and to modify the SERP, prior to presentation, under the control of the native search engine. Further the toolbar is able to track searcher interaction with the SERP and communicate significant click events and votes back to the native search engine.

### BRIEF DESCRIPTION OF THE DRAWINGS

The foregoing features of the invention will be apparent from the following Detailed Description of the Invention, taken in connection with the accompanying drawings in which:

FIG. 1 is a flow chart showing a search session, of the present invention in which the search engine has decided to adjust ResultRank by inferring the opinion of the searcher as to what the presentation order should have been;

FIG. 2 is a flow chart showing a search session, of the present invention in which the search engine has decided to insert fresh content in order to have the searcher assess the ResultRank of that fresh content;

FIG. 3 is a flow chart showing a search session, of the present invention in which the search engine has decided to collect data to be used to estimate the average searcher Reliance Metric R.

### DETAILED DESCRIPTION OF THE INVENTION

The present invention relates to a system and method for search engine result ranking. Searcher opinions as to what the SERP presentation order should have been are inferred and incorporated into future estimates of overall ranking. Fresh content is randomly chosen and selectively inserted into a portion of the SERPs in the second ranked/presentation position. The fresh content when evaluated by a searcher has its ResultRank calculated based on the top ranked result in the SERP. Insertion of fresh content presents some risk for the search engine: Fresh content may not be deemed of adequate quality by the average searcher. To continuously monitor, the average searcher's satisfaction with the search engine, data is collected to estimate a searcher reliance metric R, which is designed to vary directly with overall searcher satisfaction. This reliance metric can be used by the search engine of this invention to regulate the rate of introduction of fresh content into SERPs.

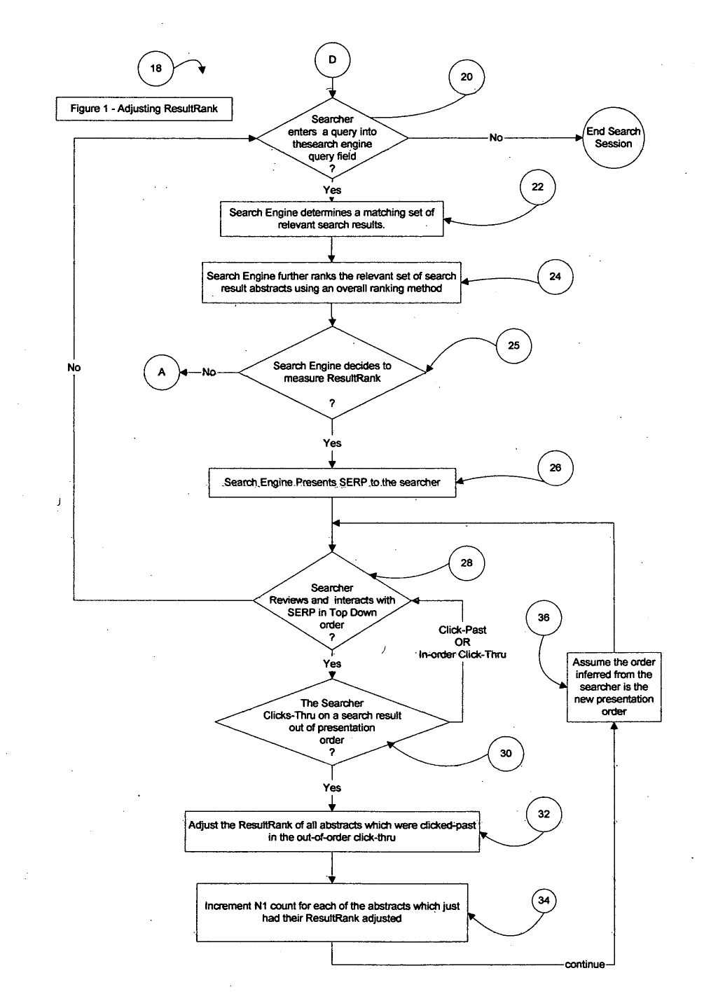

FIG. 1 is a flow chart showing the search engine of the present invention, indicated generally at 18, showing overall processing steps of the system of the present invention as the search engine interacts with a searcher. In step 20, a determination is made as to whether the searcher has entered a search query into the search engine's query entry filed. If so, step 22 is invoked, wherein the search engine determines a matching set of relevant results. In step 24 the search engine applies the algorithm of this invention to further rank the relevant set of search result abstracts into their overall ranking order. In step 25, a determination is made by the search engine as to whether or not to measure ResultRank for the generated SERP. If a positive determination is made, step 26 is invoked, wherein the search engine presents the SERP to the searcher. In step 28, the searcher reviews the SERP in a top down order and a determination is made by the searcher as to whether or not to interact with the SERP or to re-enter a revised search query.

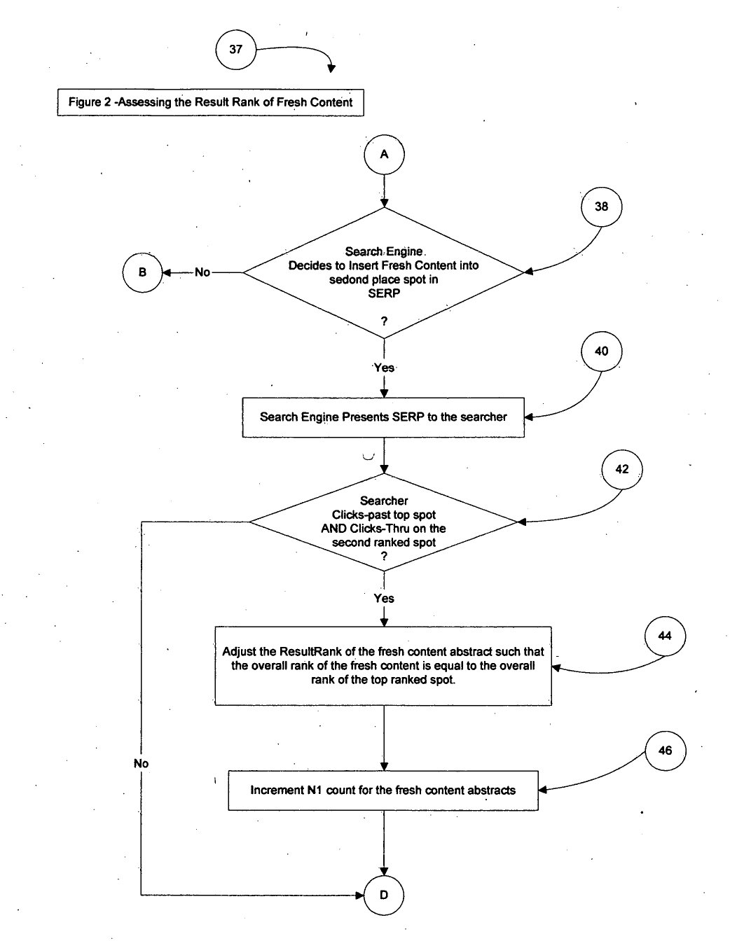

If the searcher decides to re-enter a revised search query, then step 20 is re-invoked. If the searcher decides to interact with the SERP, a determination is made as to whether or not the searcher clicks-through on a search abstract contained in the SERP in an order that does not agree with the presentation order of the SERP at step 30. If so, then step 32 is invoked, wherein the ResultRank of all abstracts which were clicked-past prior to the out of order click-through event, is adjusted in order to reflect the new overall rank of these abstracts as inferred by the search engine from the searcher's behavior. In step 34, the N1 count for associated with each of these abstracts is incremented by one to account for their ResultRank adjustment. In step 36, the new overall values calculated are taken by the search engine to determine the new order of the SERP (as if it was reordered and re-presented to the searcher) for use in any further out of presentation order determinations. Step 28 is then re-invoked in order to continue to allow the searcher to interact with the SERP. At this point the searcher's opinion of what the order of the original SERP should have been has been inferred and accounted for by the search engine. The search engine retains knowledge of this new ordering, even though anew SERP is not provided to the searcher. If the searcher makes a subsequent click-through, which is out of order with respect to this new presentation order; then ResultRank will be recalculated for each impacted abstract in order to determine yet another order change as inferred by the search engine to be the expressed opinion of the searcher. If the searcher subsequently clicks-through on an abstract, which was previously clicked-through on during the same search session, ResultRank and N1 counts will not be further adjusted. In the event that a negative determination is made at step 25, then step 38 of FIG. 2 is invoked.

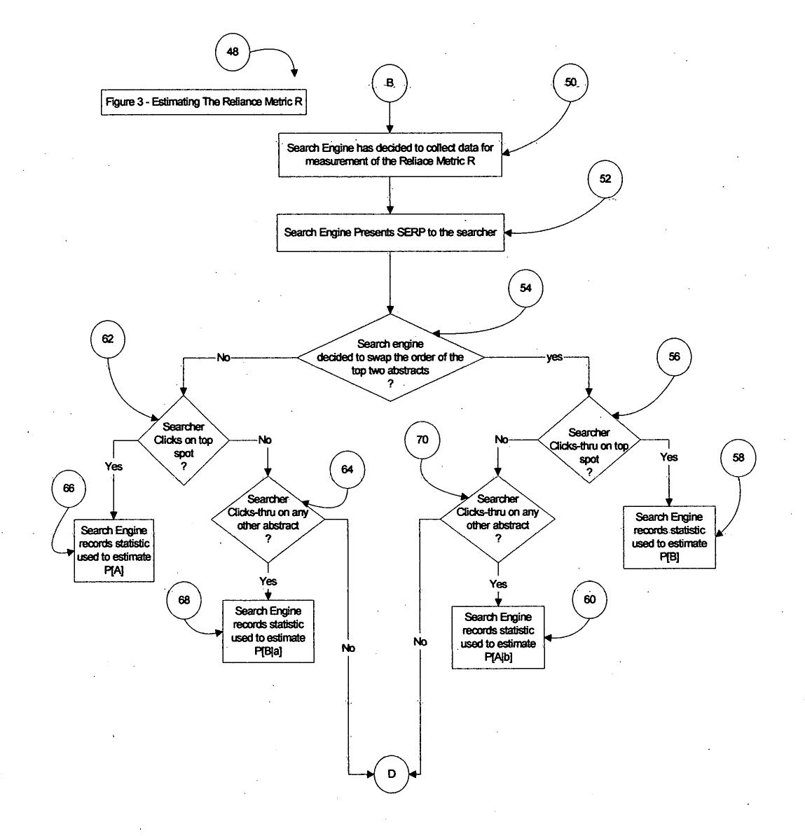

FIG. 2 is a flow chart showing the search engine of the present invention, indicated generally at 37, showing overall processing steps of the system of the present invention as the search engine interacts with a searcher. In step 38, a determination is made as to whether or not the search engine will insert fresh content into the second place spot of the SERP. If a positive determination is made, then step 40 is invoked wherein the search engine presents the SERP to the searcher. Step 42 is then invoked in which a determination is made as to whether or not the searcher has clicked past the top spot and clicked through on the second ranked spot (where the fresh content has been presented). If a positive determination is made, then step 44 is invoked and the ResultRank of the fresh content abstract is adjusted such that the overall rank of the fresh content is equal to the overall rank of the top ranked spot. Step 46 is then invoked in which the N1 count for the fresh content abstract is incremented by one. At this point, or if a negative determination was made at step 42, the searcher has the opportunity to enter a new query into the search engine query field or to end the search session. In the event that the search engine makes a negative determination at step 25, then step 50 of FIG. 3 is invoked.

FIG. 3 is a flow chart showing the search engine of the present invention, indicated generally at 48, showing the overall processing steps of the system of the present invention as the search engine interacts with a searcher. In step 50, it is assumed that the search engine has made a determination to collect data for use in estimating the value of the searcher Reliance Metric R. As such, step 52 is then invoked, wherein the search engine presents the SERP to the searcher. In step 54, a determination is made as to whether or not the search engine has decided to swap the order of the top two abstracts, and thus placing them in the reverse order based on their overall rank. If a positive determination is made, then step 56 is invoked. In step 56 a determination is made as to whether or not the searcher has clicked-through on the abstract presented in the top spot of the SERP. If a positive determination is made then the search engine records a sample that is used to estimate P[B], for use in estimating R. If a negative determination is made so at step 56, then step 70 is invoked. In step 70 a determination is made as to whether the searcher has clicked-through on any other search abstract in the SERP. If a positive determination is made, then step 60 is invoked. In step 60 the search engine records a sample used to estimate P[A|b], which in turn is used to estimate R.

If a negative determination is made at step 70, then the searcher has the choice of re-entering a new search query or terminating the search session. If a negative determination is made at step 54, then step 62 is invoked. In step 62, a determination is made as to whether the searcher has clicked-through on the search abstract presented in the top position of the SERP. If a positive determination is made, then the search engine records a statistic used to estimate P[A], which in turn is used to estimate R. If a negative determination is made at step 62, then step 64 is invoked. In step 64 a determination is made as to whether or not the searcher has clicked-through on any other abstracts in the SERP. If a positive determination is made then step 68 is invoked. In step 68, the search engine records a sample which is used to estimate P[B|a], which in turn is used to estimate R. In the event that a negative determination is made at step 64, then the searcher has the opportunity to enter a new query or terminate the search session.

1) A system for optimizing Search Engine operations on a plurality of computer networks, comprising
A search engine to crawl computer networks to scrape and index established network content;
The search engine to collect and index fresh network content;
The search engine to select a set of search results based on relevance to a received search query;
The search engine to rank the set of relevant results based on an overall ranking algorithm;
A web browser to accept search queries from users;
The web browser to transmit the search queries to the search engine;
The web browser to display search engine result presentations (SERPs) to users;
A mouse for the user to clicking-through on individual search result abstracts within the SERPs, and to scroll through the SERPs for review.

2) A method for optimizing Search Engine operations on a plurality of computer networks comprising the steps of
Using a search engine to crawl computer networks to scrape and index established content;
Using the search engine to collect and index fresh content;
Using the search engine to select a set of search results based on relevance to a received search query;
Using the search engine to rank the set of relevant results based on an overall ranking algorithm;
Using a web browser to accept search queries from users;
Using the web browser to transmit the search queries to the search engine;
Using the web browser to display search engine result presentations (SERPs) to users;
Using a mouse for the user to click-through on individual search result abstracts within the SERPs, and to scroll through the SERPs for review.

3) The method of claim 2), in which the established content is content that has non-zero overall rank.

4) The method of claim 3) in which the overall ranking algorithm is based on a combination of both ResultRank and link-based rank.

5) The method of claim 4) in which the ResultRank portion of the overall rank is weighted by N1.

6) The method of claim 5) in which the link based portion of the overall rank is weighted by N2.

7) The method of claim 6) in which the overall rank is equal to a weighted-average sum of the contribution from the ResultRank and the link-based ranking.

8) The method of claim 7) in which the overall rank is equal to the sum of the ResultRank multiplied by N1 and the link-based rank multiplied by N2, all divided by the sum of N1 added to N2.

9) The method of claim 8) in which the resulting overall ranking is used to determine the presentation order for each SERP generated, with the results being presented in-order of rank.

10) The methods of claim 9), in which click-analysis is used to infer the searcher'opinion on what the SERP presentation order should have been.

11) The method of claim 10) in which click-analysis is monitoring a searcher's click-past and click-through behavior with respect to each result in the SERP.

12) The method of claim 11) in which the order that a searcher clicks-through on abstracts in the SERP is inferred by the search engine to be the opinion of the searcher as to what the presentation order should have been in the SERP.

13) The method of claim 12) in which the ResultRank is adjusted, for each associated result abstract which was clicked-past and for the result abstract which was clicked-through on; when the click-through was done out-of-presentation-order.

14) The method of claim 13) in which the adjustment to ResultRank, of the effected result abstracts, is done in a manner that causes their overall rank to reflect the presentation order inferred to have been the opinion of the searcher.

15) The method of claim 14) in which the, range spanned by the overall rank of the ResultRank impacted abstracts, is maintained.

16) The method of claim 15) in which the overall rank value of the first abstract which was clicked-passed out-of-presentation-order, is assigned to be equal to the expression used to calculate the overall rank of the abstract that was clicked-through out-of-presentation-order.

17) The method of claim 16) in which the resulting equation is balanced by adjusting the ResultRank component of the expression.

18) The method of claim 17) in which any abstracts which were clicked-past also have their ResultRank adjusted in order to make their overall rank equal to the overall rank of the abstract which was one spot below them in the latest inferred presentation order.

19) The method of claim 18) in which an established search result is presented for the first time and as such has no initial ResultRank or N1 value, and therefore substitutes the existing link-based rank for an initial ResultRank and substitutes the existing N2 value for an initial N1 value.

20) The method of claim 19) in which a search result is presented which has no initial rank and a substitute overall rank value is calculated for the result, based on the average of the overall rank values of the results presented adjacent to it.

21) The method of claim 20) in which all required adjustments of ResultRank are completed and a new presentation order is inferred prior to beginning to adjust the ResultRank rank values, driven by a subsequent click-through event which is out-of-presentation-order based on the latest inferred order.

22) The method-of claim 21) in which subsequent searcher click-past and click-through events occurring within the same search session are defined and evaluated using the new inferred presentation order.

23) The method of claim 22) in which clicking-through on the same abstract a subsequent time in the same search session does not constitute an out-of-presentation-order click-through, and thus does not drive a ResultRank adjustment cycle.

24) The methods of claim 23) in which adjustments were made to ResultRank only when a uniquely identifiable source of the searcher activity was not responsible for clicked-through activity that caused a ResultRank adjustment to the subject search result within a selectable previous period of time.

25) The method of claim 24) further comprising the incrementing of the N1 counts associated with abstracts following each adjustment to the abstract's ResultRank.

26) The method of claim 25) in which sponsored result abstracts take the place of organic result abstracts.

27) The method of claim 26) in which the link-based rank value is replaced with the monetary unit of exchange which the sponsor initially agreed to pay for each searcher click-through on the sponsored result abstract.

28) The method of claim 27) in which the value of N2 is equal to zero for all sponsored search result abstracts.

29) The method of claim 2), in which presentation of the SERP constitutes performing part 1 of an experiment designed to calculate the R metric, in which a sample is collected and used to estimate the probabilities P[A] and P[B|a].

30) The method of claim 29), further comprising randomly swapping the order of presentation of the top ranked search result abstract A, with the second ranked abstract, B, in a selected percentage of the SERPs, in order to perform the second part of an experiment designed to determine the R metric.

31) The method of claim 30), further comprising, collecting a sample used to estimate the probabilities P[B] and P[A|b].

32) The method of claim 31), further comprising estimating each type of probability based on the number of corresponding events that were observed, divided by the total number of experiments conducted.

33) The method of claim 32), further comprising use of the estimated probabilities to re-calculate the average value of the R metric after a selectable number of experiments have been completed.

34) The method of claim 33) in which the average value of the R metric is calculated by summing, the P[A] divided by twice the P[A|b], with the P[B] divided by twice the value of P[B|a], and subtracting 1 from the sum.

35) The method of claim 2), in which the fresh content is content that has zero overall rank.

36) The method of claim 35), further comprising the search engine's insertion of a randomly selected fresh content search result abstract into the second place presentation position, of a selected percentage of the SERPs, which are otherwise generated normally based on overall rank.

37) The methods of claims 34) and 36) further comprising use of the Reliance metric R to adjust the percentage of SERPs which are randomly chosen for insertion of fresh content.

38) The method of claim 37), in which the percentage of SERPs chosen for insertion of fresh content, varies directly with the value of the Reliance metric R.

39) The methods of claims 26) and 34) in which the amount paid by the sponsor per click-through varies directly with the value of the R metric, in a previously agreed upon manner.

40) The method of claim 2) in which the search engine receiving the queries and supplying the SERPs is not a part of this invention and as such is a foreign search engine and is not the native search engine.

41) The method of claim 40) in which the web browser, in communication with the native search engine, acts as a proxy for the native search engine and is used to actively track and report searcher activity, including searcher query formulation and searcher click-through interaction, with the SERP.

42) The method of claim 41) in which the web browser intercepts the SERP returned by the foreign search engine in order to inject fresh content provided by the native search engine, into the SERP prior to presentation, for purposes of experimentation.

43) The method of claim 42) in which the experimentation is for the purpose of determining a ResultRank of this fresh content.

44) The method of claim 40) in which the web browser intercepts the SERP returned by the foreign search engine in order to swap specific results in the SERP, for purposes of experimentation.

45) The method of claim 44) in which the experimentation is done in order to determine the metric R.

46) The method of claims 43) and 45) in which the web browser used is not a part of this invention and as such is a foreign web browser and is thus not a native web browser.

47) The method of claim 46) in which the foreign web browser has had a toolbar plug-in installed into it, which is in communication with the native search engine.

48) The method of claim 47) in which the toolbar offers a voting capability for searchers in order to improve the quality of the inferences made as to searcher opinion.

49) The system of claim 1) further comprising a web browser for sending queries to and for intercepting SERPs generated by a foreign search engine.

50) The system of claim 49), wherein the web browser, in communication with and under control of the native search engine is able to modify the SERP prior to presentation.

51) The system of claim 50), wherein the web browser allows click-past and click-through events to be communicated to the native search engine.

52) The system of claim 51) wherein the means in the web browser for allowing communication between, and control by the native search engine, further comprises a toolbar plugin installed in the web browser for allowing communication between and control by the native search engine.

53) The method of claim 28) in which the ResultRank of a sponsored result is used to adjust the price that a sponsor pays on a per click basis.

54) The method of claim 53) in which the higher the ResultRank of a sponsored link, the less a sponsor pays on a per click-through basis in a previously agreed upon manner.
